(19) United States
(12) Patent Application Publication
(10) Pub. No.: US 2011/0295690 A1
(43) Pub. Date: Dec. 1, 2011

(54) PROVIDING INFORMATION TO POTENTIAL PURCHASERS ELECTRONICALLY

(75) Inventors: Benjamin J. Steinmetz, Stowe, PA (US); Dean P. Macinskas, Telford, PA (US)

(73) Assignee: Benjamin J. Steinmetz, Stowe, PA (US)

(21) Appl. No.: 12/791,316

(22) Filed: Jun. 1, 2010

(51) Int. Cl. G06Q 30/00; H04M 3/42

(52) U.S. Cl. 705/14.55; 455/414.1

(57) ABSTRACT

In a electronic curbside information system, a seller is provided with an electronic “seller unit” that can be placed in physical proximity to a display, usually an advertising sign. Potential buyers carry “buyers units” usually in the form of smart phones in which an application is downloaded and stored. The buyer unit is programmed to communicate with the seller unit and store a unique identification associated with the seller unit. In a “profile server”, accessible over a public global communications network, the unique identification of each seller unit is associated with detailed product information, and is accessible directly by the buyer unit if the buyer unit can gain access to the global network. Alternatively, the identification stored in the buyer unit can be transferred to the buyer's personal computer, which can then communicate over the global network with the profile server and download the product details.

### FIELD OF THE INVENTION

This invention relates to an electronic apparatus for providing information to potential purchasers of products (including services as well as goods), and to a method for providing information using an electronic apparatus.

### BACKGROUND OF THE INVENTION

Currently, a residential property is typically advertised by a sign placed near the house at a location at which it is visible to a passing motorist. The sign typically identifies the real estate agency with which the home is listed, the name of an individual agent, and a telephone number. The sign may also carry other information such as an indentification of the agency's website, but typically lacks sufficient space for details such as the number of rooms, details on the heating system, land area, and amenities.

An interested potential purchaser can obtain details by memorizing the name of the real estate agency and, later, viewing the detailed information usually posted on the agency's website. A potential purchaser who views more than a few homes advertised for sale during a single outing will find it necessary to record the homes' addresses and associate the addresses with the identities of the listing agencies. Recording such information using a pencil and paper, or even with an electronic personal assistant, can be cumbersome and inconvenient. Moreover, unless the potential purchaser's primary objective is to search for real estate, he or she may be unprepared to record information.

A solution used in some localities is for the seller or agency to provide details on printed information sheets placed in a protective box adjacent the advertising sign. However, this approach has several drawbacks. The supplies of information sheets are depleted at unpredictable rates, and must be checked frequently. Moreover, in some cases it is inconvenient for the passing motorist to stop, to pick up an information sheet, especially on a busy street having limited space for parking.

Other products, such as automobiles offered for sale by their owners, are advertised in a similar manner by means of signs posted on or adjacent to the products, usually with the owner's telephone number.

Similarly, services, and unique products, are advertised by signs visible to motorists and pedestrians, but in many instances the signs have insufficient space to carry all of the information that potential purchasers require in order to make a decision on whether or not to pursue their interest. The potential purchasers must record information such as the identity of the advertiser, a telephone number, or a web address, and obtain the the desired details later. A percentage of the potential purchasers who see the advertising sign will either forget about it, or lose interest by the time they reach a destination at which they can make a telephone call or look up the advertiser's website. Consequently a sizable number of lost sales is an inherent drawback associated with conventional sign advertising.

### SUMMARY OF THE INVENTION

This invention is a system that benefits potential purchasers by enabling them to obtain details concerning advertised products quickly and conveniently, and that benefits sellers by making their sign and display advertising more effective. The invention can take advantage of the broad availablity of so-called “smart phones” that have a wireless local area network connection capability under IEEE standard 802.11, referred to as “WiFi”, or a similar wireless local area network connection capability.

Briefly, in the system according to the invention, a seller is provided with an electronic device, referred to herein as a “seller unit,” or SU, that can be placed in physical proximity to a display, usually an advertising sign. Potential buyers carry “buyers units” or BUs, usually in the form of smart phones in which an application (“app”) is downloaded and stored. The BU is programmed to communicate with the SU and store a unique identification associated with the SU. In a “profile server” (PS), accessible over a public global communications network, e.g., the “Internet,” the unique identification of each SU is associated with detailed product information, and is accessible directly by the BU if the BU has an Internet access capability. Alternatively, the identification stored in the BU can be transferred to the buyer's personal computer, which can then communicate over the Internet with the profile server (PS) and download the product details.

More particularly, the apparatus of the invention is applicable where each of a plurality of products is advertised to the public by means of a different one of a plurality of displays. The apparatus comprises a plurality of seller units, at least one buyer unit, and a profile server.

Each seller unit is associated with, and in close proximity to, a display. Each seller unit includes a wireless radio module and a processor connected to the radio module.

Each buyer unit comprises a wireless communication module, a memory storing a program for recording in the memory data received by the wireless communication module, and a processor.

The profile server, which is a server on a global communications network, stores detailed information concerning each advertised product, and is programmed to receive, over the global communications network, requests each including a unique identification associated with a seller unit, and to respond to each such request by returning information concerning the product advertised by the display associated with said seller unit.

The processor of each seller unit is programmed to cause the wireless radio module thereof to transmit a unique identification. The processor of the buyer unit is controllable to accept and store the unique identification sent by the seller unit. The processor of each seller unit can also be programmed to transmit beacon packets identifying the seller unit as an information device.

The apparatus also includes means responsive to a unique identification stored in the buyer unit for transmitting a request to the profile server and for displaying returned information concerning an advertised product corresponding to the seller unit with which the stored unique identification is associated.

The buyer unit is preferably a mobile telephone having a wireless communication capability, in which case it is unnecessary to utilize special hardware for the buyer unit portion of the apparatus. The program for recording data in the memory of the buyer unit can be a software application stored in the memory of the buyer unit. Moreover, if the buyer unit is a mobile telephone having wireless access to a global communications network, the program stored in the memory of the buyer unit for recording data in the memory of the buyer unit can be a software application downloaded from the global communications network.

Where the buyer unit is mobile telephone having wireless access to said global communications network, the means responsive to a unique identification stored in the buyer unit for transmitting a request to the profile server and for displaying returned information can be contained within the mobile telephone itself. Alternatively, the apparatus may include a terminal connectible through a communication link with the buyer unit to receive a unique identification stored in the buyer unit, and capable of communication with the global public communication network, and the means responsive to a unique identification stored in the buyer unit for transmitting a request to the profile server and for displaying returned information can be contained within the terminal.

The communication between a seller unit and the buyer unit can be one-way communication, that is, transmission of unique identifications repeatedly from the seller unit so that they can be received by a nearby buyer unit. However, in that case, the power consumption of the seller unit may be excessive, especially if it is battery-powered. Power consumption can be alleviated by two-way communication. Thus, if processor of the buyer unit is controllable to cause the wireless communication module of the buyer unit to transmit a query to a seller unit, and the processor of each seller unit is programmed to respond to said query by causing the wireless radio module of the seller unit to return a unique identification to the buyer unit, the seller unit can operate as a receiver only unless queried, or it can periodically transmit packets identifying itself as an information source, but only transmit unique identifications in response to a query from a buyer unit.

Another aspect of the invention is a method for providing information to potential purchasers of products. Each product is advertised to the public by means of a different one of a plurality of displays. In a preferred method according to the invention, each of a plurality of seller units is associated with, and positioned in close proximity to, a display. Each seller unit includes a wireless radio module. A seller unit is caused to transmit a unique identifier corresponding to the product advertised by the display with which the seller unit is associated over a wireless communication link to a mobile buyer unit in close proximity to the display associated with that seller unit. The received unique identifier is stored in a memory in the mobile buyer unit.

Information concerning the product advertised by each of display is stored in a profile server accessible through a public global communications network and associating in the profile server with the unique identifier corresponding to that product. By transmitting the unique identifier stored in the memory of the mobile buyer unit over the public global communication network, a buyer can retrieve stored information concerning that product.

The apparatus and method according to the invention provides an system which benefits a potential purchaser by enabling the purchaser to obtain detailed information concerning an advertised product easily and conveniently. At the same time, the apparatus and method can also benefit a seller by increasing the effectiveness of an advertising display.

Further objects and advantages of the invention will be apparent from the following description when read in conjunction with the drawings.

### BRIEF DESCRIPTION OF THE DRAWINGS

FIG. 1 is a schematic diagram showing a part of the apparatus, consisting of plural seller units, each associated with a display, and a buyer unit;

FIG. 2 is a schematic diagram showing another part of the apparatus, consisting of a profile server in communication over a public global communication network, with a seller terminal, a plurality of buyer terminals, and also directly with a buyer unit;

FIG. 3 is a table illustrating a set of buyer unit set-up options;

FIGS. 4-11 are representations of selected screenshots on the screen of a smart phone used as a buyer unit; and

FIG. 12 is a table illustrating packet definitions for a Service Set Identifier (SSID), an identifier (ID), a response packet returned by the Seller Unit (SU), a buyer unit ID request, a buyer unit profile request, and a profile returned by the profile server.

### DETAILED DESCRIPTION OF THE PREFERRED EMBODIMENTS

The term “in close proximity” as used herein with reference to a seller unit and a display means that the seller unit and display are within a distance such that wireless local area network communication can take place between the Seller Unit and a Buyer Unit close enough to the display that an individual carrying the Buyer Unit can read the display. Most wireless communication devices according to the IEEE 802.11 standard can communicate reliably over a distance of about 100 meters outdoors. The distance between a Seller Unit and a display can be considered to be in close proximity if the Seller Unit and display are less than approximately 100 meters apart. Preferably the distance is not greater than 30 meters, and in most instances, the distance will be much less than 30 meters.

The invention will be described in the context of an apparatus used for advertising residential real estate. However, it should be understood that the apparatus is useful in advertising other products, including both goods and services.

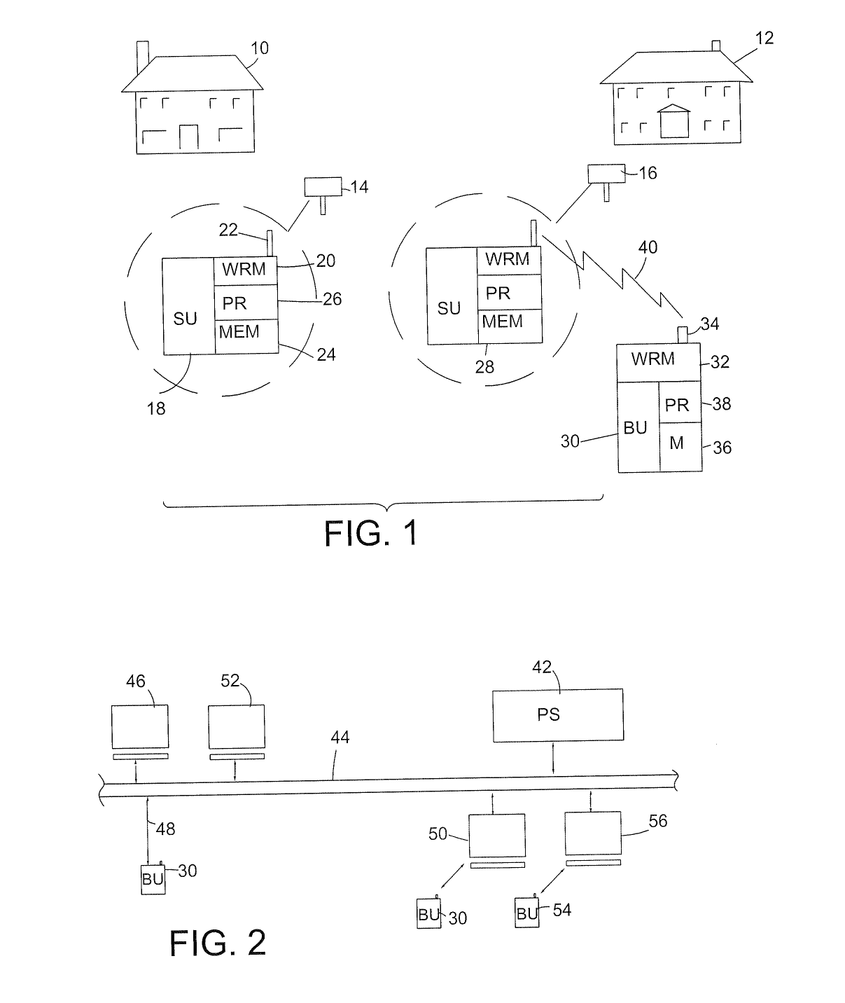

As shown in FIG. 1, a first house 10 and a second house 12 are both offered for sale, and advertised respectively by yard signs 14 and 16. Yard sign 14 is in close proximity to a first Seller Unit SU 18, which can be built into, or attached to, the sign. Preferably, however, in order to avoid theft of the Seller Unit, the unit is hidden at a location where it is unlikely to be found. If the house is within a relatively short distance, e.g., 100 meters or less, from the road on which the property is located, the Seller Unit can be located on the house itself, for example on a second story window sill. Alternatively, the Seller Unit can be attached to a tree near the road, or hidden at some other suitable location close enough to the road to provide reliable short range wireless access.

The Seller Unit includes a wireless radio module 20, an antenna 22 connected to the module, a memory 24 and a processor 26. The wireless radio module is preferably a two-way wireless communication module, i.e., one having both transmitting and receiving capabilities. However, in an alternative embodiment, the wireless radio module can be a one-way communication module having only a transmitting capability and no receiving capability.

A second Seller Unit 28 is similarly associated with house 12, and situated in close proximity to advertising sign 16. The memory in each of the Seller Units stores a unique identification code which, as will appear later, is associated in a profile server with detailed information concerning the attributes of the property to which it pertains.

A buyer module (BU) 30, is preferably a “smart phone,” having a wireless local area network communication capability, and is in communication with Seller Unit 28. The Buyer Unit 30 includes a wireless communication module 32, an antenna 34, a memory 36 and a processor 38. The processor is capable of running a program or application, preferably downloadable into the memory 36 from a public global communication network such as the Internet. The wireless communication module 30 has at least a receiving capability, and preferably a two-way communication capability.

In the operation of the apparatus as thus far described, Buyer Unit 30 can communicate, through a wireless link with any Seller Unit. In FIG. 1, the Buyer Unit 30 is in communication with Seller Unit 28 through a wireless link 40.

The Seller Units are preferably programmed to transmit packets, i.e., Service Set Identifiers (SSIDs), that serve as beacons identifying the seller units as information sources. These service set identifiers can include identifications that uniquely identify each seller unit. Alternatively, the seller unit ID can be transmitted separately upon request by a Buyer Unit. The processor in the Buyer Unit is preferably programmed to notify the individual carrying the Buyer Unit that the Buyer Unit is in the vicinity of a Seller Unit, and to give the individual the opportunity to connect. Alternatively, the connection can be made automatically. When the connection is made, the Seller Unit will assign an IP address using the Dynamic Host Configuration Protocol (DHCP), a computer networking protocol used by hosts (DHCP clients) to retrieve IP addresses and other configuration information. DHCP uses a client-server architecture. The client sends a broadcast request for configuration information. The DHCP server responds to the request by sending configuration information from its configuration database.

When the Buyer Unit has received the IP address, it automatically sends a request for a unique identifier to the Seller Unit, which, in turn responds by sending the identifier to the Buyer Unit, where it is stored. If the Seller Unit is de-commissioned and has no valid identifier, it will return a response packet so indicating, and the Buyer Unit will discard the response packet. In either case, after storing or discarding the response, the Buyer Unit and Seller Unit will disconnect automatically.

Because the connections between the Buyer Unit and the Seller Units are anonymous and transient, it is unnecessary to utilize network cryptographic security, e.g., WEP or WPA.

The Buyer Unit includes a public key certificate that is used to verify a signature included in the identification packet transmitted by the Seller Unit. A valid signature indicates that the identification is genuine and that it came from an authorized Seller Unit.

The buyer can move on to other displays and collect other identifiers from the Seller Units associated with those displays in a similar manner. Identifiers collected by the Buyer Unit are stored in an identifier cache in the memory of the Buyer Unit.

As shown in FIG. 2, a profile server 42 is available on a global public communication network 44. One or more sellers can communicate with the profile server 42 through terminals such as seller terminal 46, in order to upload detailed information on a product associated with a Seller Unit. Preferably, a seller will rent or purchase one or more Seller Units, which are commissioned, i.e., linked to the seller. The seller, using a seller terminal, can populate a seller template in the profile server with details concerning the product with which the Seller Unit is to be associated. The Seller Unit can then be positioned in close proximity to the display which advertises that product.

If the Buyer Unit is equipped to communicate with the global network 44 over a wide area communication network 48, such as a 3G network, the user of the Buyer Unit can immediately establish a connection with the profile server 42 and, by transmitting a stored identifier to the profile server, retrieve and display detailed information concerning the product corresponding to that identifier. The user can then make a decision on whether or not the product is of interest, and either delete the identifier from the cache or retain it. The user can then select another identifier from the cache and display information on another product.

Subsequently, if the user so chooses, the Buyer Unit 30 can be connected to a personal computer (PC) 50 set up as a terminal in communication with the public network 44. When the Buyer Unit is connected to the PC, the stored identifiers can be used to retrieve product details from the profile server, which can then be viewed in greater detail on the personal computer display screen, and printed if desired.

An apparatus according to the invention can include additional seller terminals such as seller terminal 52, and a large number of Buyer Units such as Buyer Unit 54. The apparatus may also include a large number of buyer terminals such as terminal 56.

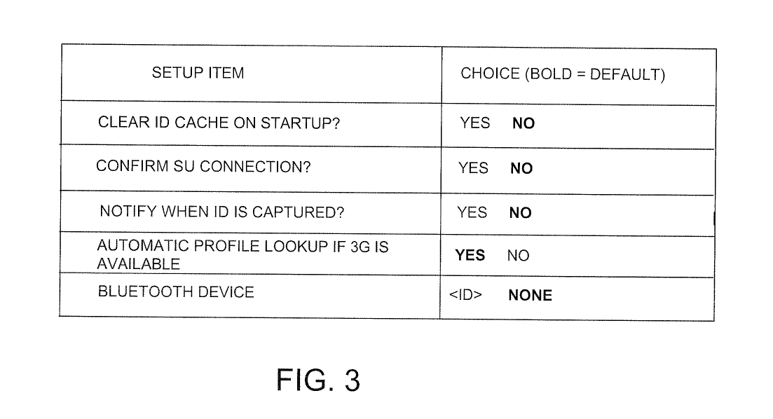

The following is a description of further details of a preferred embodiment of the apparatus. The set-up of the Buyer Unit includes a number of user-selectable options as depicted in FIG. 3. The default condition is indicated in bold type. However, by pressing a button on the Buyer Unit, the user can modify the set-up options. Thus, the user can select an option that will cause the cache of identifiers to be cleared on start-up of the Buyer Unit. Another option will enable the Buyer Unit to confirm a connection to a Seller Unit. This option can be used if the user of the buyer unit prefers, for security, to inspect the Service Set Identifier (SSID), before connecting to the seller unit. Still another option will enable the Buyer Unit to notify the user automatically when an identifier is captured. In the case of a Buyer Unit having a wide area network (e.g., 3G) communication capability, the user can select a set-up mode in which the Buyer Unit automatically transmits a captured identifier to the profile server causing a product profile to be downloaded automatically. Finally, the user can select an option by which a Bluetooth interface is enabled in order to connect the Buyer Unit to a buyer personal computer (PC).

When an identifier is submitted to the profile server, the server checks its validity. If the identifier is invalid, the server returns an error message. If the identifier is valid and the product profile, i.e., detailed product information is available, the server streams the profile to the device, either a Buyer Unit or a buyer terminal that is used to request the profile. The product profile is essentially an HTML-encoded web page, which can be rendered natively, i.e., displayed as an HTML-coded profile, or displayed using a resident browser in the Buyer Unit or in the buyer's terminal. The product profile can be rendered natively if the operating system in the Buyer Unit has an HTML-rendering Application Programming Interface (API). Mobile telephones using the ANDROID operating system software of Google, Inc. have a native HTML-rendering API.

The system can be implemented using standard, readily available components, suitably programmed to carry out the functions that are described below.

In a preferred embodiment, the procedural flow is as follows:

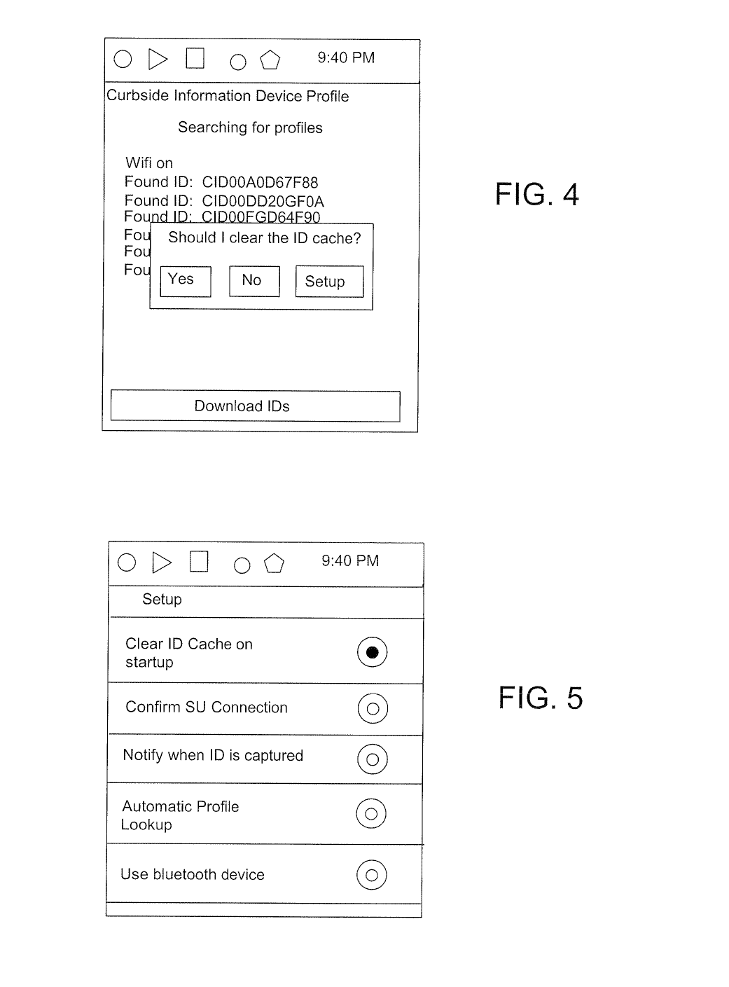

The default operation of the Buyer Unit (BU) is to look for Seller Units (SUs). The steps in the operation of the Buyer Unit are preferably the following:
1. Initialization
   a. Present initial screen (FIG. 4).
   b. Clear the SSID (Service Set Identifier) cache.
   c. Offer to clear the ID cache or clear it automatically if enabled.
d. Enable the wireless 802.11 interface.
2. Wait for SSID.
3. When SSID arrives, determine whether or not it conforms to a prescribed format, specifically:
   a. Total length=13 bytes;
   b. The first 5 bytes are “CID00”.
4. If the SSID does not conform to the prescribed format, ignore it and return to step 2.
5. If the SSID is already in the BU cache, ignore it and return to step 2.
6. Connection loop:
   a. Connect to the access point (SU) and get an IP address via DHCP.
   b. Open a socket on a Transmission Control Protocol (TCP) port, for example port 20101, and send an ID request to the SU
      I. Wait up to 10 seconds for a reply.
      ii. If a timeout occurs close the socket and disconnect from the access point.
      iii. After a predetermined number of tries, display the SSID with an error message: “no response.”
      iv. Put the SSID in the cache and return to step 2.
7. Get and process ID response:
   a. Put SSID in SSID cache and disconnect from the access point.
   b. Verify that the SSID has the correct length.
   c. Verify signature using embedded public key.
   d. Extract the ID, and, add to the ID cache if not already there.
   e. If notification mode is enabled, notify the user that an ID was successfully captured.
   f. if ID lookup is disabled go to step 8.
   g. If WAN (3G) connection is unavailable, notify user and go to step 8.
   h. Connect to profile server. If profile server is not available, go to step 8.
   I. Submit ID to server, and get profile.
   j. Display profile. Present buttons for option to “delete ID” or “close”.
   k. If user selects “close,” discard profile.
   l. If user selects “delete ID”, discard profile and delete ID from cache.
8. If user has not selected “ID download”, go to step 2.
9. Disable wireless 802.11 interface.
10. Enable Bluetooth interface.
11. Attempt to connect to default device in setup profile.
12. If connection attempt is successful, copy ID cache contents to peer.
13. Notify user that transfer was successful.
14. Prompt to clear ID cache, and clear if requested.
15. Close Bluetooth connection and go to step 2.

FIG. 4 illustrates a typical Buyer Unit display screen on startup when the first set-up option (first item in FIG. 3) is in the default mode. The user is given the opportunity to clear the ID cache, leave the ID cache in place, or return to a set-up mode. If the set-up mode is selected, the BU screen display will be as shown in FIG. 5, and the user is presented with a set of options corresponding to those in FIG. 3. When the “Use Bluetooth Device” option is selected, and one or more enabled Bluetooth devices are nearby, a picklist of available Bluetooth devices is presented, from which the user can select one for association with the Buyer Unit.

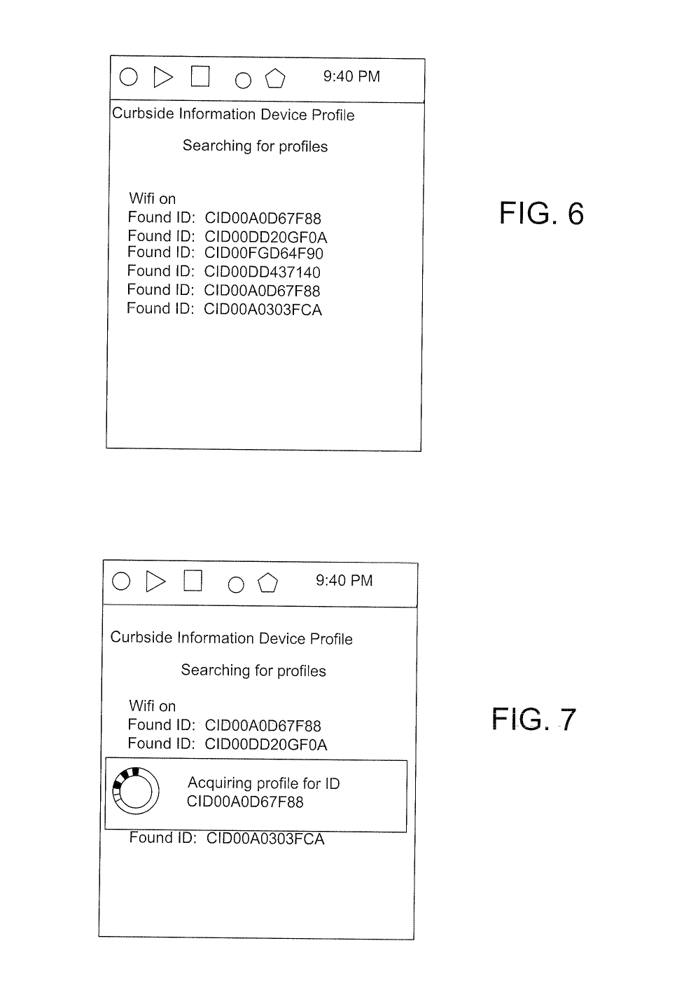

FIG. 6 shows a typical Buyer Unit screen displayed when the Buyer Unit is searching for a Seller Unit and already has several product identifiers in its cache.

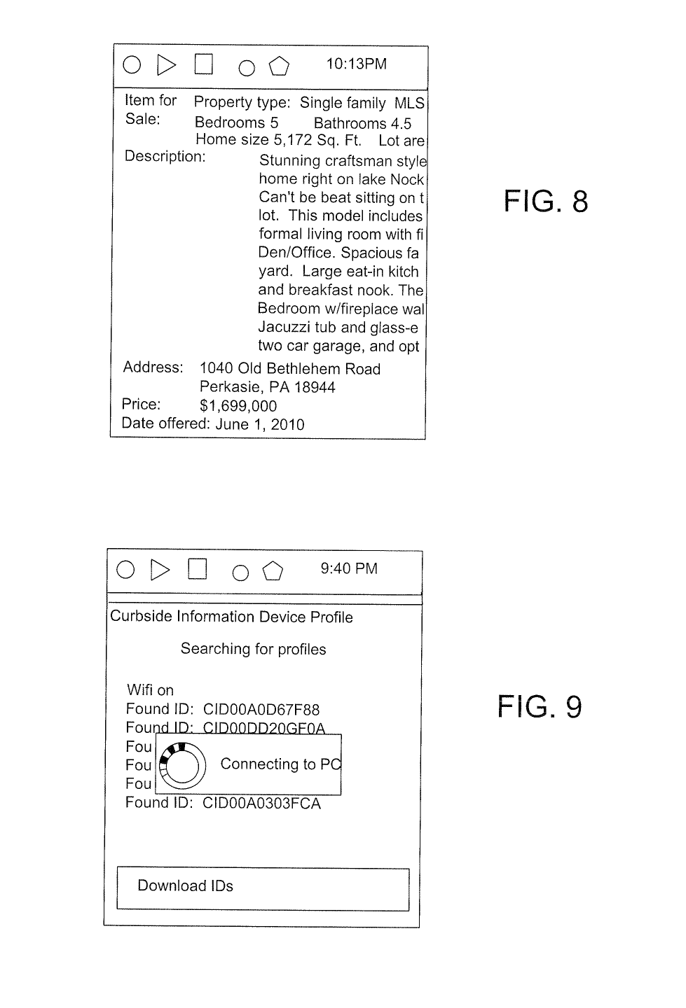

FIG. 7 shows the screen display during automatic profile retrieval, when the fourth option in FIG. 3 is selected. When the Buyer Unit acquires a valid Seller Unit identifier, and is able to recover the corresponding product profile, the profile will appear on the Buyer Unit display screen. A typical profile display is illustrated in FIG. 8. If the profile cannot be compressed into the available space without degradation, as in the case illustrated in FIG. 8, the user can mover the profile information by scrolling.

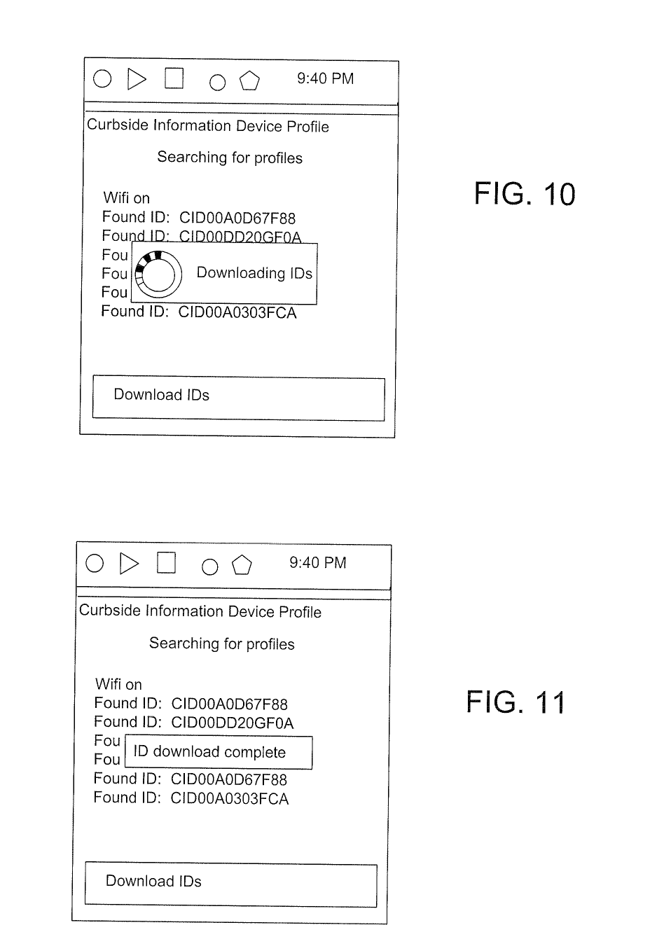

If the user wishes to download captured product identifiers to a PC for storage or profile retrieval, the user may establish a Bluetooth association between the Buyer Unit and the PC using standard platform tools to do so, by selecting an association as the default in the set-up mode. Once an association is established, the user can invoke a PC application, start a Buyer Unit application on the Buyer Unit, and press an ID download button, which will appear on the Buyer Unit. As the Buyer Unit attempts to establish a connection with the PC, the display will be as shown in FIG. 9. When the connection is established, the display will be as shown in FIG. 10, and when the download is complete, the final display will be as shown in FIG. 11.

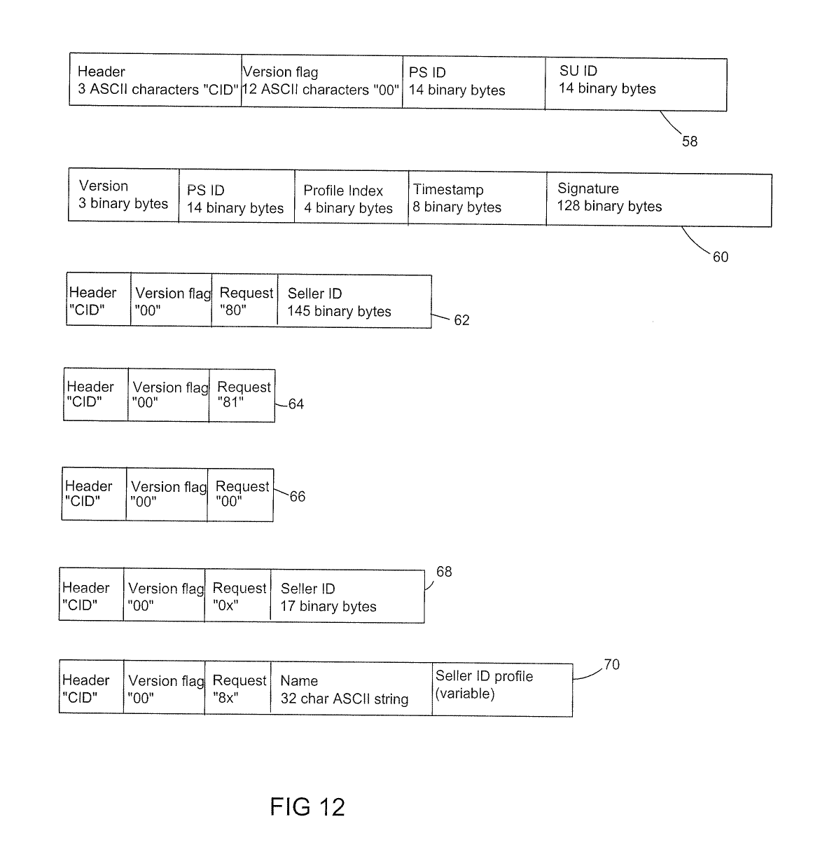

Typical packet definitions are as illustrated in FIG. 12. Packet 58 is a service set identifier SSID which has a specific structure that allows the Buyer Unit application to identify it. Packet 60 is a product profile ID. The Seller Unit (SU) prepends an ASCII header to the seller ID, so that the entire response packet sent to the Buyer Unit is packet 62, which includes a header CID (for “Curbside Identification Device”, followed by a version flag “00”, a request number, e.g., “80”, and the full 145 byte seller profile ID.

If the Seller Unit is uncommissioned or has lost its seller ID, it will return a packet such as packet 65, which lacks the seller ID.

Packet 66 is the packet sent by the Buyer Unit to request a seller ID, and packet 68 is a packet sent by the Buyer Unit or the buyer's PC as a profile request. The request field notifies the profile server that the request is coming from a Buyer Unit or from a buyer PC.

Finally, the profile returned by the profile server to the Buyer Unit or to the buyer PC is illustrated by packet 70, wherein the request field varies depending on whether the request to which the packet is responsive came from a Buyer Unit or from a buyer PC.

What is claimed is:

1. An electronic apparatus for providing information to potential purchasers of products, each advertised to the public by means of a different one of a plurality of displays, the apparatus comprising:
a plurality of seller units, each seller unit being associated with, and in close proximity to, a display, and each seller unit including a wireless radio module and a processor connected to the radio module;
a buyer unit comprising a wireless communication module, a memory storing a program for recording in said memory data received by said wireless communication module, and a processor; and
a profile server on a global communications network, said profile server storing detailed information concerning each said advertised product, and programmed to receive, over said global communications network, requests each including a unique identification associated with a seller unit, and to respond to each of said requests by returning information concerning the product advertised by the display associated with said seller unit;
wherein:
the processor of each said seller unit is programmed to transmit a unique identification;
the processor of the buyer unit is controllable to accept and store the unique identification sent by the seller unit;
the apparatus also comprising:
means responsive to a unique identification stored in the buyer unit for transmitting a request to the profile server and for displaying returned information concerning an advertised product corresponding to the seller unit with which said stored unique identification is associated.

2. An electronic apparatus according to claim 1, in which the buyer unit is a mobile telephone.

3. An electronic apparatus according to claim 2, in which the program for recording data in the memory of the buyer unit is a software application stored in the memory of the buyer unit.

4. An electronic apparatus according to claim 1, in which the buyer unit is a mobile telephone having wireless access to said global communications network, and in which the program for recording data in the memory of the buyer unit is a software application downloaded from said global communications network and stored in the memory of the buyer unit.

5. An electronic apparatus according to claim 1, in which the buyer unit is a mobile telephone having wireless access to said global communications network, and in which the means responsive to a unique identification stored in the buyer unit is contained within said mobile telephone.

6. An electronic apparatus according to claim 1, including a terminal connectible through a communication link with the buyer unit to receive a unique identification stored in the buyer unit, and capable of communication with said global public communication network, and in which the means responsive to a unique identification stored in the buyer unit is contained within said terminal.

7. An electronic apparatus according to claim 1, in which the processor of the buyer unit is controllable to cause the wireless communication module of the buyer unit to transmit a query to a seller unit, and in which the processor of each seller unit is programmed to respond to said query by causing the wireless radio module of the seller unit to return a unique identification to the buyer unit.

8. An electronic apparatus according to claim 1, in which the processor of each said seller unit is also programmed to cause the wireless radio module thereof to transmit beacon packets identifying the seller unit as an information device;

9. A method for providing information to potential purchasers of products, each product being advertised to the public by means of a different one of a plurality of displays, the method comprising:
associating each of a plurality of seller units with, and positioning each seller unit in close proximity to, a display, each seller unit including a wireless radio module;
causing a seller unit to transmit a unique identifier corresponding to the product advertised by the display with which the seller unit is associated over a wireless communication link to a mobile buyer unit in close proximity to the display associated with that seller unit;
storing said unique identifier in a memory in said mobile buyer unit; and
storing information concerning the product advertised by each of said displays in a profile server accessible through a public global communications network and associating the information on each such advertised product in the profile server with the unique identifier corresponding to that product; and
by transmitting said unique identifier stored in the memory of the mobile buyer unit over said public global communication network, retrieving the stored information concerning that product.
